(19) United States
(12) Patent Application Publication
(10) Pub. No.: US 2019/0025882 A1
(43) Pub. Date: Jan. 24, 2019

(54) PLATE MEMBER, CASING INCLUDING PLATE MEMBER AND MANUFACTURING METHOD THEREOF

(71) Applicant: Compal Electronics, Inc., Taipei City (TW)

(72) Inventors: Han-Ching Huang, Taipei City (TW); Po-An Lin, Taipei City (TW); Jung-Chin Wu, Taipei City (TW); Kuo-Nan Ling, Taipei City (TW)

(21) Appl. No.: 16/036,809

(22) Filed: Jul. 16, 2018

Related U.S. Application Data
(60) Provisional application No. 62/533,627, filed on Jul. 17, 2017.

(51) Int. Cl. G06F 1/16; B32B 27/06

(52) U.S. Cl. CPC G06F 1/1633; B32B 2457/00; B32B 27/065

(57) ABSTRACT

A casing including a plate member and a resin member is provided. The plate member has a bottom surface and includes a first surface layer, a second surface layer and a core layer. The first surface layer has a plurality of first through holes and disposed on at least one edge of the first surface layer. The first surface layer and the second surface layer are oppositely disposed on two sides of the core layer. The resin member covers edges and the bottom surface of the plate member and has an extension portion. The extension portion extends between the first surface layer and the second surface layer and adjacent to the core layer. The extension portion further extends to the plurality of first through holes. A manufacturing method of the casing is also provided.

### FIELD OF THE INVENTION

The present invention relates to a casing, and more particularly to a casing composed of a plate member and a manufacturing method thereof.

### BACKGROUND OF THE INVENTION

Among various electronic devices, computers have become an indispensable important product in human life. As technology advances, the functionality and speed of computers continue to grow, so that computers have developed from a large machine in the early days to desktops and notebooks.

In terms of market trends, the two key requirements for notebook computer are volume reduction and weight reduction. In addition to the microelectronic components in the computer, the choice of computer casing materials is also the focus of development. The conventional notebook computer uses a plastic casing, and although the cost is inexpensive, it is obviously insufficient in strength after being thinned to reduce volume and weight. Therefore, other materials have been developed, such as the use of relatively new materials, for example, glass fiber, carbon fiber or composite materials to manufacturing a casing. However, for the casing made of composite materials, there is still room for improvement in the balance between strength and weight.

### SUMMARY OF THE INVENTION

The present invention provides a casing, which can improve the mechanical strength and achieve the effect of weight reduction.

The present invention provides a manufacturing method of a casing, which can produce a casing having the above advantages.

A casing provided by the invention includes a plate member and a resin member. The plate member has a bottom surface and includes a first surface layer, a second surface layer and a core layer. The first surface layer has a plurality of first through holes disposed on at least one edge of the first surface layer. The first surface layer and the second surface layer are oppositely disposed on two sides of the core layer. The resin member covers edges and the bottom surface of the plate member and has an extension portion. The extension portion extends between the first surface layer and the second surface layer and adjacent to the core layer. The extension portion further extends to the plurality of first through holes.

In one embodiment of the invention, at least one edge of the plate member has at least one concave portion and at least one convex portion interlaced with each other.

In one embodiment of the invention, materials of the first surface layer and the second surface layer are respectively carbon fiber, glass fiber, rayon, natural fiber, metal, alloy, plastic or a combination thereof.

In one embodiment of the invention, a material of the core layer is a polymer foam material.

In one embodiment of the invention, the plate member further includes a first adhesive layer and a second adhesive layer. The first surface layer has a first surface facing the core layer. The second surface layer has a second surface facing the core layer. The first adhesive layer is disposed on the first surface, the second adhesive layer is disposed on the second surface, and the core layer is sandwiched between the first adhesive layer and the second adhesive layer. The first adhesive layer has a plurality of second through holes corresponding to the plurality of first through holes, and the extension portion extends to the plurality of second through holes.

In one embodiment of the invention, a maximum aperture of the first through hole is greater than a thickness of the core layer.

In one embodiment of the invention, the thickness of the core layer is 0.1 mm to 1 mm.

A manufacturing method of a casing provided by the invention includes the following steps. Providing a plate member, wherein the plate member has a bottom surface and includes a first surface layer, a second surface layer, and a core layer, the first surface layer and the second surface layer are oppositely disposed on two sides of the core layer, and the first surface layer has a plurality of first through holes disposed on at least one edge of the first surface layer. Placing the plate member in a molding die, and injecting and curing a filler to form a resin member, wherein the resin member covers edges and the bottom surface of the plate member and has an extension portion. The extension portion extends between the first surface layer and the second surface layer and adjacent to the core layer, and the extension portion further extends to the plurality of first through holes.

In one embodiment of the invention, at least one edge of the plate member has at least one concave portion and at least one convex portion interlaced with each other.

In one embodiment of the invention, the plate member further includes a first adhesive layer and a second adhesive layer. The first surface layer is adhered to the core layer by the first adhesive layer, and the second surface layer is adhered to the core layer by the second adhesive layer.

In one embodiment of the invention, the method further includes thermally laminating a laminated structure of the first surface layer, the second surface layer, the first adhesive layer, the second adhesive layer and the core layer.

In one embodiment of the invention, the first adhesive layer has a plurality of second through holes corresponding to the plurality of first through holes, and the extension portion further extends to the plurality of second through holes.

In one embodiment of the invention, a maximum aperture of the first through hole is greater than a thickness of the core layer.

In one embodiment of the invention, the thickness of the core layer is 0.1 mm to 1 mm.

In one embodiment of the invention, the molding die has a plurality of recess portions, and the plurality of recess portions correspond to the plurality of first through holes of the first surface layer.

The casing of the embodiment of the invention includes a plate member and a resin member. The first surface layer of the plate member has a plurality of first through holes disposed on at least one edge of the first surface layer, so that when the filler is injected between the first surface layer and the second surface layer, it can be partially diverted to the plurality of first through holes to reduce the degree of compression of the core layer, and to reduce the weight of the plate member and the casing, thereby achieving an effect of weight reduction. In addition, the extension portion of the resin member formed by the cured filler, which is partially diverted into the plurality of first through holes, can also strengthen the bonding ability of the resin member and the first surface layer, thereby improving the mechanical strength of the casing. Since the manufacturing method of the casing of the embodiment of the invention uses the above-mentioned plate member, it is possible to produce a casing having the above advantages.

For making the above and other purposes, features and benefits become more readily apparent to those ordinarily skilled in the art, the preferred embodiments and the detailed descriptions with accompanying drawings will be put forward in the following descriptions.

### BRIEF DESCRIPTION OF THE DRAWINGS

FIG. 1 is a schematic bottom view of a casing of an embodiment of the present invention;

FIG. 2 is a schematic cross-sectional view taken along the line A-A′ of the casing of FIG. 1;

FIG. 3 is a schematic view of a plate member of an embodiment of the present invention;

FIG. 4 is a schematic flow chart of a manufacturing method of a casing according to an embodiment of the present invention;

FIG. 5 is a schematic cross-sectional view taken along the line B-B′ of the plate member of FIG. 3; and

FIG. 6 is a schematic cross-sectional view showing a plate member placed in a molding die of an embodiment of the present invention.

### DETAILED DESCRIPTION OF PREFERRED EMBODIMENTS

In the following detailed description of the preferred embodiments, a range represented by “a value to another value” is a schematic representation that avoids listing all the values in the range in the specification. Therefore, the recitation of a particular range of values is equivalent to the disclosure of any value in the range of values and a smaller range of values defined by any value within the range of values, as if the arbitrary values and the smaller range of values are written in the specification. For example, the description of the range of “10 mm-100 mm” is equivalent to disclosing the range of “20 mm-50 mm”, regardless of whether other values are listed in the specification.

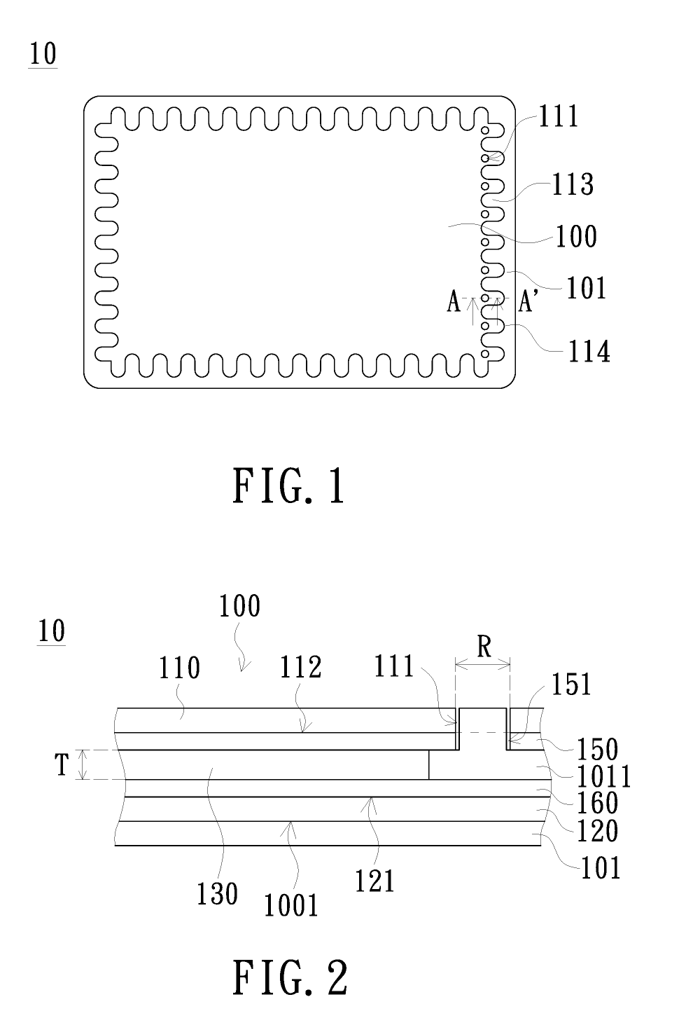

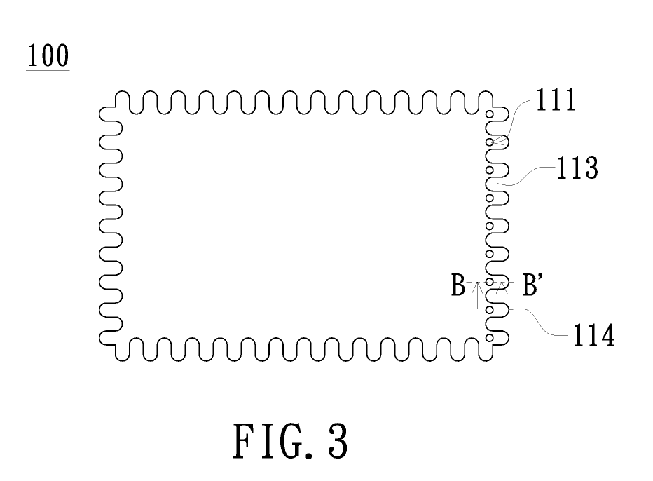

FIG. 1 is a schematic bottom view of a casing of an embodiment of the present invention. FIG. 2 is a schematic cross-sectional view taken along the line A-A′ of the casing of FIG. 1. FIG. 3 is a schematic view of a plate member of an embodiment of the present invention. Referring to FIG. 1 to FIG. 3, a casing 10 of the present embodiment includes a plate member 100 and a resin member 101. The casing 10 has a plurality of surfaces, and at least one surface is composed of the plate member 100 and the resin member 101. The plate member 100 may be, for example, a composite material. The plate member 100 has a bottom surface 1001 and includes a first surface layer 110, a second surface layer 120 and a core layer 130. The first surface layer 110 has a plurality of first through holes 111 disposed on at least one edge of the first surface layer 110. The first surface layer 110 and the second surface layer 120 are oppositely disposed on two sides of the core layer 130. The resin member 101 covers the edges and the bottom surface 1001 of the plate member 100 and has an extension portion 1011. The extension portion 1011 extends between the first surface layer 110 and the second surface layer 120 and adjacent to the core layer 130. The extension portion 1011 further extends to the plurality of first through holes 111.

The materials of the first surface layer 110 and the second surface layer 120 may be respectively, for example, carbon fiber, glass fiber, rayon, natural fiber, metal, alloy, plastic or a combination thereof, but are not limited thereto. Different fiberizing materials may also be used in other embodiments to improve the mechanical strength of the plate member 100.

The material of the core layer 130 may be a polymer foam material, and may be, for example, polycarbonate (PC), polyethylene terephthalate (PET), polymethyl methacrylate (PMMA), polyethylene (PE), acrylonitrile-butadiene-styrene (ABS), polyamide (PA), polypropylene (PP), polystyrene (PS), etc., but is not limited thereto. Other lightweight materials may also be used.

The resin member 101 is formed by injecting a filler toward the plate member 100 and curing the filler. The filler includes, for example, a plastic or other filling material. In addition, a portion of the filler is injected between the first surface layer 110 and the second surface layer 120. The filler overflows through the first through holes 111 and becomes the extension portion 1011 of the resin member 101 after cured. The relationship between the extension portion 1011 and the first through holes 111 will be described in detail below.

During the manufacturing process of the casing 10, a portion of the filler is injected from an edge of the plate member 100, and the filler presses the core layer 130 when injected. Taking the material of the core layer 130 as a polymer foam material as an example, since the polymer foam material has the micro-gap structure, a non-uniform boundary is formed when the filler presses the core layer 130. The boundary between the core layer 130 and the extension 1011 in FIG. 2 is only an example. When the filler excessively presses the core layer 130, the weight of the plate member 100 is increased. Therefore, a plurality of first through holes 111 are disposed on at least one edge of the first surface layer 110, so that the filler injected from the at least one edge of the plate member 100 can be partially diverted to the first through holes 111 to reduce the excessive pression of the core layer 130 by the filler, and the boundary between the core layer 130 and the extension portion 1011 can be more uniform.

Since the function of the first through holes 111 is used to partially divert the filler, the first through holes 111 only need to be disposed at the edge where the filler is injected. For example, if the filler is injected into one side of the plate member 100, the first through holes 111 only need to be disposed on the same side of the first surface layer 110. In addition, in order to improve the partially diverting function of the first through holes 111, the maximum aperture R of each of the first through holes 111 is larger than the thickness T of the core layer 130, so that the filler can be partially diverted to the first through holes 111 when injected. The thickness T of the core layer 130 is, for example, 0.1 mm to 1 mm.

The edge of the plate member 100 may have at least one concave portion 113 and at least one convex portion 114 interlaced with each other, but is not limited thereto. In other embodiments, the edge of the plate member 100 may not have the concave portion 113 and the convex portion 114 or have a plurality of concave portions 113 and a plurality of convex portions 114 interlaced with each other. The structure of the concave portion 113 and the convex portion 114 can improve the bonding ability between the plate member 100 and the resin member 101, thereby improving the mechanical strength of the casing 10. In FIG. 3, all the edges of the plate member 100 have the concave portion 113 and the convex portion 114. However, depending on the design requirements, only a part of the edges have the structure of the concave portion 113 and the convex portion 114.

The casing of the present embodiment of the present invention includes a plate member 100 and a resin member 101. The first surface layer 110 of the plate member 100 has a plurality of first through holes 111 disposed on at least one edge of the first surface layer 110. Therefore, when the filler is injected between the first surface layer 110 and the second surface layer 120, the filler can be partially diverted to the plurality of first through holes 111 to reduce the degree of the pression of the core layer 130 and to reduce the weight of the plate member 100 and the casing 10, thereby achieving an effect of weight reduction. In addition, the extension portion 1011 of the resin member 101, formed by the cured filler partially diverted into the plurality of first through holes 111, can also strengthen the bonding ability of the resin member 101 and the first surface layer 110, thereby improving the mechanical strength of the casing 10.

The plate member 100 further includes a first adhesive layer 150 and a second adhesive layer 160. The first adhesive layer 150 and the second adhesive layer 160 may be, for example, adhesives, but not limited thereto. The first surface layer 150 has a first surface 112 facing the core layer 130. The second surface layer 160 has a second surface 121 facing the core layer 130. The first adhesive layer 150 is disposed on the first surface 112, and has a plurality of second through holes 151 corresponding to the plurality of first through holes 111. When the filler is injected between the first surface layer 110 and the second surface layer 120, the filler may be further filled in the second through holes 151. The second adhesive layer 160 is disposed on the second surface 121, and the core layer 130 is sandwiched between the first adhesive layer 150 and the second adhesive layer 160.

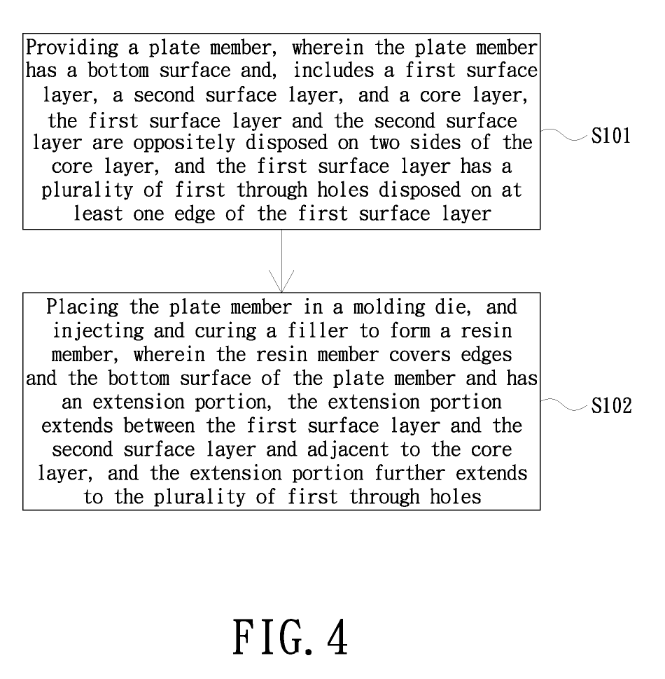

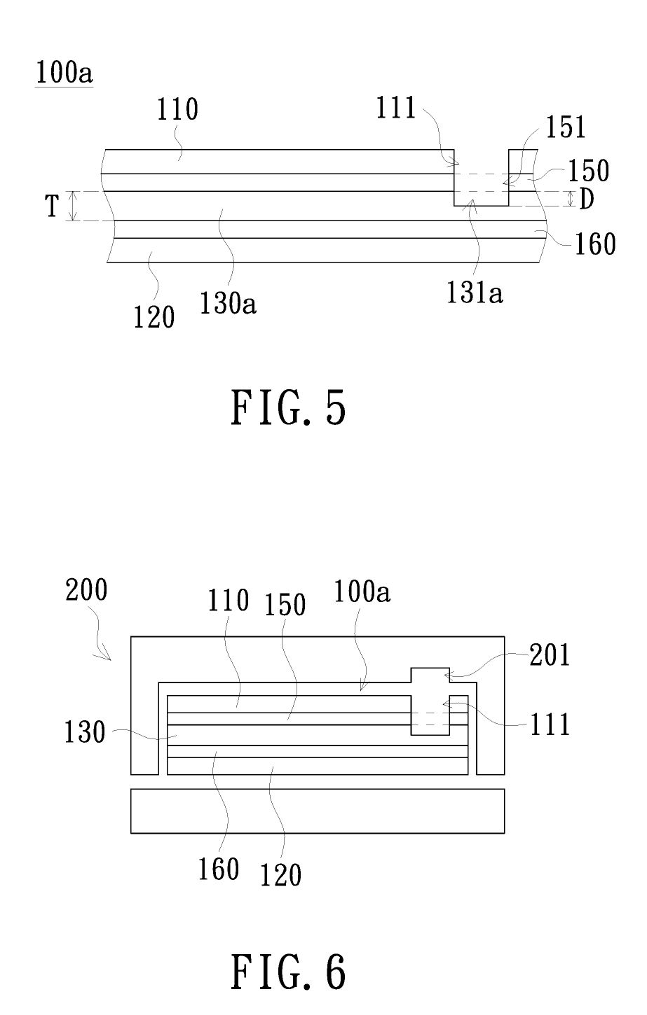

The following will be described in detail for the manufacturing process of the casing 10. FIG. 4 is a schematic flow chart of a manufacturing method of a casing of an embodiment of the present invention. FIG. 5 is a schematic cross-sectional view taken along the line B-B′ of the plate member of FIG. 3. FIG. 6 is a schematic cross-sectional view showing a plate member placed in a molding die of an embodiment of the present invention. Referring to FIG. 4 to FIG. 6, the manufacturing method of the casing 10 of the present embodiment includes the following steps. Step S101: providing a plate member 100a having a bottom surface 1001 and including a first surface layer 110, a second surface layer 120 and a core layer 130a. The first surface layer 110 and the second surface layer 120 are oppositely disposed on two sides of the core layer 130, and the first surface layer 110 has a plurality of first through holes 111 disposed on at least an edge of the first surface layer 110.

Specifically, the first surface layer 110 is adhered to the core layer 130a by, for example, the first adhesive layer 150, and the second surface layer 120 is adhered to the core layer 130a by, for example, the second adhesive layer 160, so as to form a laminated structure. Then the laminated structure is thermally laminated to form the plate member 100a. In addition, the first adhesive layer 150 has a plurality of second through holes 151 corresponding to the plurality of first through holes 111. The first through holes 111 and the second through holes 151 are formed, for example, by punching, and may, for example, penetrate into the core layer 130a. That is, the core layer 130a has third through holes 131a corresponding to the first through holes 111 and the second through holes 151. The depth D of the third through hole 131a is, for example, less than or equal to the thickness T of the core layer 130a.

Continuing to refer to FIG. 4 and FIG. 6, step S102: placing the plate member 100a in a molding die and injecting and curing a filler to form a resin member 101, wherein the resin member 101 covers the edges and the bottom surface 1001 of the plate member 100a and has an extension portion 1011. The extension portion 1011 extends between the first surface layer 110 and the second surface layer 120 and adjacent to the core layer 130a. The extension portion 1011 further extends to the plurality of first through holes 111. Specifically, in step S102, the plate member 100a is placed in a molding die and a filler is injected, and the molding die may be, for example, an injection molding die, but not limited thereto. As shown in FIG. 6, the molding die 200 of the embodiment has, for example, a plurality of recess portions 201 corresponding to the plurality of first through holes 111 of the first skin layer 110, and the recess portion 201 is a partially diverting accommodation space for accommodating the filler.

When the filler is injected between the first surface layer 110 and the second surface layer 120, the core layer 130a may be pressed (the core layer 130a becomes the core layer 130 after pressed, so that the plate member 100a becomes the plate member 100). A portion of the filler is partially diverted to the recess portions 201 of the molding die 200 through the second through holes 151 and the first through holes 111, so that the degree of pression of the core layer 130a is reduced. After the filler is cured to form the resin member 101 (shown in FIG. 2), the casing 10 having an effect of weight reduction can be obtained. The extension portion 1011 of the resin member 101 formed by the cured filler in the first through holes 111 and the second through holes 151 can also strengthen the bonding ability between the resin member 101 and the first surface layer 110, and thus the mechanical strength of the casing 10 is improved.

In summary, the casing of the embodiment of the present invention includes a plate member and a resin member. The first surface layer of the plate member has a plurality of first through holes disposed on at least one edge of the first surface layer. Therefore, when a filler is injected between the first surface layer and the second surface layer, the filler can be partially diverted to the plurality of first through holes to reduce the degree of pression of the core layer and to reduce the weight of the plate member and the casing, thereby achieving an effect of weight reduction. In addition, the extension portion of the resin member, formed after the filler partially diverted into the plurality of first through holes is cured, can also strengthen the bonding ability of the resin member and the first surface layer, thereby improving the mechanical strength of the casing. Since the manufacturing method of the casing of the embodiment of the present invention uses the above-mentioned plate member, a casing having the above advantages can be manufactured.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

### ELEMENT SYMBOL DESCRIPTION

10: casing
100, 100a: plate member
1001: bottom surface
101: resin member
1011: extension portion
110: first surface layer
111: first through hole
112: first surface
113: concave portion
114: convex portion
120: second surface layer
121: second surface
130, 130a: core layer
131a: third through hole
150: first adhesive layer
151: second through hole
160: second adhesive layer
200: molding die
201: recess portion
S101, S102: step
D: depth
R: aperture
T: thickness

What is claimed is:

1. A casing, comprising:
a plate member, having a bottom surface, wherein the plate member comprises:
a first surface layer, having a plurality of first through holes disposed on at least one edge of the first surface layer;
a second surface layer; and
a core layer, wherein the first surface layer and the second surface layer are oppositely disposed on two sides of the core layer; and
a resin member, covering edges and the bottom surface of the plate member, wherein the resin member has an extension portion, the extension portion extends between the first surface layer and the second surface layer and adjacent to the core layer, and further extends to the plurality of first through holes.

2. The casing according to claim 1, wherein at least one edge of the plate member has at least one concave portion and at least one convex portion interlaced with each other.

3. The casing according to claim 1, wherein materials of the first surface layer and the second surface layer are respectively carbon fiber, glass fiber, rayon, natural fiber, metal, alloy, plastic or a combination thereof.

4. The casing according to claim 1, wherein a material of the core layer is a polymer foam material.

5. The casing according to claim 1, wherein the plate member further comprises a first adhesive layer and a second adhesive layer, the first surface layer has a first surface facing the core layer, the second surface layer has a second surface facing the core layer, the first adhesive layer is disposed on the first surface, the second adhesive layer is disposed on the second surface, the core layer is sandwiched between the first adhesive layer and the second adhesive layer, the first adhesive layer has a plurality of second through holes corresponding to the plurality of first through holes, and the extension portion extends to the plurality of second through holes.

6. The casing according to claim 1, wherein a maximum aperture of the first through hole is greater than a thickness of the core layer.

7. The casing according to claim 6, wherein the thickness of the core layer is 0.1 mm to 1 mm.

8. A manufacturing method of a casing, comprising:
providing a plate member, wherein the plate member has a bottom surface and comprises a first surface layer, a second surface layer, and a core layer, the first surface layer and the second surface layer are oppositely disposed on two sides of the core layer, and the first surface layer has a plurality of first through holes disposed on at least one edge of the first surface layer; and
placing the plate member in a molding die, and injecting and curing a filler to form a resin member, wherein the resin member covers edges and the bottom surface of the plate member and has an extension portion, the extension portion extends between the first surface layer and the second surface layer and adjacent to the core layer, and the extension portion further extends to the plurality of first through holes.

9. The manufacturing method of the casing according to claim 8, wherein at least one edge of the plate member has at least one concave portion and at least one convex portion interlaced with each other.

10. The manufacturing method of the casing according to claim 8, wherein the plate member further comprises a first adhesive layer and a second adhesive layer, the first surface layer is adhered to the core layer by the first adhesive layer, and the second surface layer is adhered to the core layer by the second adhesive layer.

11. The manufacturing method of the casing according to claim 10, further comprising:
thermally laminating a laminated structure of the first surface layer, the second surface layer, the first adhesive layer, the second adhesive layer and the core layer.

12. The manufacturing method of the casing according to claim 10, wherein the first adhesive layer has a plurality of second through holes corresponding to the plurality of first through holes, and the extension portion further extends to the plurality of second through holes.

13. The manufacturing method of the casing according to claim 8, wherein a maximum aperture of the first through hole is greater than a thickness of the core layer.

14. The manufacturing method of the casing according to claim 13, wherein the thickness of the core layer is 0.1 mm to 1 mm.

15. The manufacturing method of the casing according to claim 8, wherein the molding die has a plurality of recess portions, and the plurality of recess portions correspond to the plurality of first through holes of the first surface layer.
